(19) United States
(12) Patent Application Publication
(10) Pub. No.: US 2026/0181423 A1
(43) Pub. Date: Jun. 25, 2026

(54) METHOD FOR TRANSMITTING DATA VIA A WIRELESS INTERFACE BETWEEN A FIELD DEVICE AND A MOBILE DEVICE

(71) Applicant: Endress+Hauser Conducta GmbH+Co. KG, Gerlingen (DE)

(72) Inventors: Reinhard Griech, Riehen (CH); Patrice Grosperrin, Rixheim (FR); Björn Haase, Stuttgart (DE); Philipp Heinrich Kindt, Sonthofen (DE)

(21) Appl. No.: 19/421,226

(22) Filed: Dec. 16, 2025

(30) Foreign Application Priority Data
Dec. 20, 2024 (DE) 10 2024 139 199.5
Mar. 20, 2025 (DE) 10 2025 110 773.4

(51) Int. Cl. H04W 24/02; H04W 4/80; H04W 24/08

(52) U.S. Cl. CPC H04W 24/02; H04W 4/80; H04W 24/08

(57) ABSTRACT

A method for transmitting data via a wireless interface between a field device and a mobile device comprises configuring first connection parameters with a first transmission power, a first redundancy and a first packet length, wherein the first transmission power corresponds to a maximum transmission power, the first redundancy to a minimum redundancy and the first packet length to a minimum packet length, so that an internal power limit is not exceeded by the field device; transmitting a first advertising message from the field device via the first wireless interface with the first connection parameters; receiving the first advertising message from the mobile device via the second wireless interface; and transmitting a first response message from the mobile device to the field device.

### CROSS-REFERENCE TO RELATED APPLICATION

The present application is related to and claims the priority benefit of German Patent Application No. 10 2024 139 199.5, filed on December 20, 2024, and German Patent Application No. 10 2025 110 773.4, filed March 20, 2025, the entire contents of which are incorporated herein by reference.

### TECHNICAL FIELD

The present disclosure relates to a method for transmitting data via a wireless interface between a field device and a mobile device, and to a system.

### BACKGROUND

In analytical measurement technology, especially in the fields of water management, of environmental analysis, in industry, e.g., in food technology, biotechnology, and pharmaceutics, as well as for the most varied laboratory applications, measured variables, such as the pH, the conductivity, or even the concentration of analytes, such as ions or dissolved gases in a gaseous or liquid measurement medium, are of great importance. These measured variables can be acquired and/or monitored for example by means of electrochemical sensors, such as optical, potentiometric, amperometric, voltammetric, or coulometric sensors, or also conductivity sensors.

These sensors are usually connected to a so-called transmitter, which processes the sensor signals and communicates them to a control center, for example. One type of connection between the transmitter and the control center is made via just two cables. In this case, the transmitter is also called a two-wire device.

With such two-wire devices, the available power is severely limited, which makes such devices particularly suitable for use in potentially explosive environments. These devices communicate using an energy-efficient HART protocol, which is designed for signals between 4 and 24 mA via a current loop between, for example, the control center and the two-wire device. The minimum available current is usually limited to 3.6 mA at a supply voltage of usually a maximum of approximately 17 V. This results in an available power of approximately 61 mW.

In many devices, the operating voltage is also further reduced in order to be able to supply additional consumers such as explosion-proof resistors or other devices in the current loop. This further reduces the available power. For example, the iTEMP TMT72 transmitter from Endress+Hauser can be operated with a minimum supply voltage of only approximately 10 V, which results in an available minimum power of only 36 mW.

However, the SoCs currently used in many transmitters with integrated Bluetooth communication modules have peak power consumption of up to approximately 30 mW for wireless communication, while on average they typically require significantly less than 1 mW for their communication tasks.

While on average there is enough power from the current loop for all device functions of the transmitter except Bluetooth, only about 6 mW are temporarily available for functions such as measuring the sensor value, processing and fieldbus communication, since the rest is used for Bluetooth communication. The total power consumption of the device may therefore briefly exceed the power provided by the current loop.

In order to cover this short-term energy demand, energy is usually temporarily stored in an energy storage device (e.g., a capacitor). The size of the required energy storage depends on the duration and magnitude of the power peaks.

However, this has the disadvantage that additional or larger electronic components are required and, furthermore, the power available in the transmitter is increased to a greater level than the power provided by the current loop. This makes it difficult to meet explosion protection (“Ex”) requirements.

Another possibility would be to put the Bluetooth communication module into sleep mode for a higher proportion of time in order to save energy. However, this has the disadvantage that the data rate and latency of the Bluetooth connection are negatively affected.

### SUMMARY

It is therefore an object of the present disclosure to propose a method which allows the transmitter to be operated in an energy-efficient manner and, at the same time, the data to be transmitted optimally.

This object is achieved according to the present disclosure by a method for transmitting data via a wireless interface between a field device and a mobile device according to claim 1.

The method according to the present disclosure comprises:

providing a field device with a processing unit and a first wireless interface, and with a mobile device having a second wireless interface, wherein an internal power limit and a minimum connection robustness are stored in the field device;

configuring first connection parameters with a first transmission power, a first redundancy and a first packet length,

wherein the first transmission power corresponds to a maximum transmission power, the first redundancy to a minimum redundancy and the first packet length to a minimum packet length, so that the internal power limit is not exceeded by the field device;

transmitting a first advertising message from the field device via the first wireless interface with the first connection parameters;

receiving the first advertising message from the mobile device via the second wireless interface;

transmitting a first response message from the mobile device to the field device;

receiving the first response message from the field device;

determining a first signal strength and a first packet error rate on the basis of the first response message by the processing unit;

determining a first connection robustness between the field device and the mobile device on the basis of the first signal strength and the first packet error rate by the processing unit;

comparing the first connection robustness with the minimum connection robustness;

transmitting a first data message with the first connection parameters if the first connection robustness is less than or equal to the minimum connection robustness;

configuring second connection parameters with a second transmission power, a second redundancy and a second packet length,

wherein the second transmission power is less than the first transmission power, the second redundancy is greater than the first redundancy, and the second packet length is greater than the first packet length, so that the internal power limit is not exceeded by the field device, and transmitting the first data message with the second connection parameters if the first connection robustness is greater than the minimum connection robustness.

The method according to the present disclosure makes it possible to provide optimal data transmission while at the same time complying with a desired energy consumption.

According to one embodiment of the present disclosure, the first wireless interface and the second wireless interface are each a Bluetooth low energy module and are each capable of transmitting at a first data rate or at a second data rate, wherein the second data rate is greater than the first data rate,

wherein the first connection parameters further comprise the first data rate and the second connection parameters further comprise the second data rate.

According to a further embodiment of the present disclosure, the first connection parameters have a first redundancy bit number and the second connection parameters have a second redundancy bit number, wherein the first redundancy bit number is greater than the second redundancy bit number.

According to one embodiment of the present disclosure, the first connection parameters have a first telegram length and the second connection parameters have a second telegram length, wherein the first telegram length is smaller than the second telegram length.

According to one embodiment of the present disclosure, an algorithm, energy model, or error model configures the second connection parameters when the first connection robustness is greater than the minimum connection robustness.

According to one embodiment of the present disclosure, after transmitting the first data message, all previously performed steps are repeated until the first connection robustness is less than or equal to the minimum connection robustness.

According to one embodiment of the present disclosure, the first data message has a first phase position, and the method further comprises receiving the first data message at the mobile device, transmitting a second data message with a second phase position, receiving the second data message at the field device, evaluating the first phase position and the second phase position, and determining a distance between the field device and the mobile device on the basis of the evaluation.

According to one embodiment of the present disclosure, the processing unit stores a transmission time when transmitting the first data message, and the method further comprises receiving the first data message at the mobile device, transmitting a second data message, receiving the second data message at the field device, storing a reception time of the second data message at the field device by the processing unit, determining a signal propagation time on the basis of the transmission time and reception time, and determining a distance between the field device and the mobile device on the basis of the signal propagation time.

The aforementioned object is further achieved by a system according to claim 9.

The system according to the present disclosure comprises:

a field device with a first wireless interface;

a mobile device with a second wireless interface,

wherein an internal power limit is stored in the field device,

wherein the system is suitable for carrying out the method according to the present disclosure.

According to one embodiment of the present disclosure, the first wireless interface and the second wireless interface are each a Bluetooth interface, preferably a Bluetooth low energy interface.

### BRIEF DESCRIPTION OF THE DRAWINGS

The present disclosure is explained in more detail on the basis of the following description of the figures, in which:

FIG. 1 is a schematic representation of a system according to the present disclosure for carrying out the method according to the present disclosure; and

FIG. 2 is a flowchart of the method according to the present disclosure for optimizing energy consumption and reliability of the connection.

### DETAILED DESCRIPTION

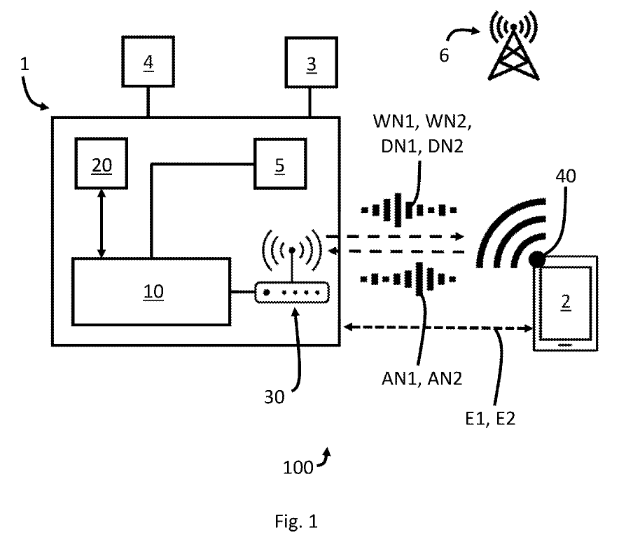

FIG. 1 schematically shows a system 100 according to the present disclosure with a field device 1 and a mobile device 2. The field device 1 comprises a first processing unit 10, a second processing unit 20 and a first wireless interface 30 for communication with a second wireless interface 40 of the mobile device 2.

The first processing unit 10 and the second processing unit 20 are connected to each other to exchange commands and/or data, which is represented in FIG. 1 by the double arrow. For example, the two processing units are connected to each other via a bidirectional, wired communication interface. The second processing unit 20 is suitable for executing computing tasks, for example creating or processing packets and cryptographic computing tasks.

The first processing unit 10 is moreover connected to the first wireless interface 30 in order to transmit commands and/or data to the first wireless interface 30. The first wireless interface 30 is preferably a Bluetooth module, particularly advantageously a Bluetooth low energy module or a module for wireless communication using other protocols (e.g., ZigBee, Wireless HART or a communication protocol based on the IEEE 802.15.4 transmission protocol, etc.). The first wireless interface 30 can be located in the same system-on-a-chip with one or both processing units, or can be implemented as a separate IC.

The field device 1 is suitable for being connected to an external energy source 3 having an external power level and for being operated with an internal power level, wherein the internal power level is less than or equal to the external power level. The external energy source 3 is, for example, a current loop with a current of 4 to 20 mA. The current loop is shown in FIG. 1 only in an abstract manner. For example, the external power level is between 36 mW and 61 mW. Of course, the field device 1 is also suitable for operation with an internal energy source, for example a battery. However, operating the field device 1 without a battery has the advantage that the field device 1 can be used, for example, in an explosion-proof environment without any additional effort. Moreover, no batteries need to be replaced over the lifetime of the field device 1.

The field device 1 is preferably a two-wire device which is suitable for communicating with a control center via the current loop using the HART protocol and for being supplied with energy at the same time.

The field device 1 is connected, for example, to a sensor 4, which supplies electrical signals, for example voltage potentials, to the field device 1. For example, these signals are processed by the field device 1 and transmitted via the current loop to the control center and/or via the first wireless interface 30 to the mobile device 2.

The system 100 preferably comprises a repeater 6, which is suitable for amplifying a signal exchanged between the field device 1 and the mobile device 2 or for increasing the range by transmitting the signals via two separate hops. The repeater 6 thus allows communication over longer distances.

The method according to the present disclosure for transmitting data via the wireless interface 30 between a field device 1 and a mobile device 2 is described in more detail below. The goal is, in particular, to transmit a first data message DN1 from the field device 1 to the mobile device 2. The first data message DN1 preferably has a predetermined number of payload data bits and a predetermined number of redundancy bits.

First, the system 100 described above is provided, which comprises the field device 1 with a processing unit 10 and a first wireless interface 30, and a mobile device 2 with a second wireless interface 40, wherein an internal power limit is stored in the field device 1.

Range when establishing a connection:

Subsequently, a first advertising message WN1 is transmitted from the field device 1 via the first wireless interface 30. Such first advertising message WN1 is a so-called advertising, i.e., a type of information about the fact that a field device 1 exists and, for example, sensor data can be retrieved from the field device 1. One could also refer to this as advertisement.

This first advertising message WN1 contains, for example, information about the serial number of field device 1, the device name, and/or about the sensor(s) 4 connected to field device 1.

Furthermore, the first advertising message WN1 is received by the mobile device 2 via the second wireless interface 40. For this purpose, it is assumed that the mobile device 2 is naturally within the range of the signal transmitted sent by the field device 1 (here: the first advertising message WN1).

When transmitting the advertising message, various connection parameters, such as the transmission power and the number of packets, can be varied. The lowest possible energy consumption by the field device can be achieved if advertising messages are transmitted as rarely as possible and with the lowest possible transmission power. However, a reduced range can be problematic. For example, if a Bluetooth device is mounted on a tank at a high altitude, the range may not be sufficient to wirelessly reach smartphones/tablets on the ground if the transmission power is reduced. This prevents both the establishment of a connection and the reception of broadcast data transmitted via advertising and scanning. Therefore, if no connection has yet been established, it is advisable to always transmit the advertising packets required to detect the presence of the device, here for example the first advertising message WN1, with high, preferably maximum, transmission power. However, this means that with a limited energy budget, only a reduced number of packets can be transmitted per unit of time (e.g., within one minute). For example, if 60 packets can be transmitted per unit of time at maximum transmission power, 600 packets could have been transmitted per unit of time at minimum transmission power. Due to transmitting at maximum transmission power, high latencies can occur when establishing a connection; i.e., it may take a long time for the smartphone to successfully receive the first data message DN1 from the field device and exchange the message pairs necessary to establish a connection.

According to the present disclosure, this problem can be alleviated by the following procedure: The majority of the advertising packets, i.e., the advertising messages, are transmitted with low transmission power. At the same time, individual, rarer advertising packets are transmitted with high transmission power. Here, the term “rare” means, for example, 1 packet out of 100 packets, preferably 1 packet out of 200 packets, or even less. This only slightly increases the average energy consumption and therefore only slightly affects the latency when establishing the connection. At the same time, remote devices can still establish a connection – albeit with increased latency. When using Bluetooth, extended advertising can also be used for even greater ranges. This is compatible only with newer devices that support Bluetooth 5 or newer, but allows the use of a coded physical layer with forward error correction even during establishment of the connection (which includes advertising). Such method for range-optimized connection establishment is preferably activated or deactivated by the user in order to adapt the device to the requirements regarding range, throughput and latency.

### Adaptive adjustment of connection parameters:

After receiving the advertising message WN1, a first response message AN1 is transmitted from the mobile device 2 to the field device 1. The first response message AN1 contains, for example, a request for further data from the field device.

The response message can further be used to request a synchronous connection between both devices in order to exchange further packet pairs after such synchronization. The configuration of the connection parameters, both during the asynchronous exchange of messages (referred to as “advertising and scanning” in Bluetooth low energy) and in a synchronous connection, determine the energy consumption of the wireless communication. At the same time, this determines the performance of the wireless connection. The required transmission power, in turn, substantially determines the necessary configuration of the connection parameters. Hereinafter, methods are described that aim to adaptively estimate the necessary transmission power and, on the basis thereof, optimize the relevant connection parameters.

### Estimation of transmission power:

If there is no synchronous connection yet, i.e., if advertising and response messages are exchanged, a first distance E1 between the field device 1 and the mobile device 2 is determined by the first processing unit 10 or the second processing unit 20. Here, the first distance is equivalent to a first connection quality or first connection robustness. In case of obstacle-free communication, the connection quality and connection robustness are usually, naturally, high at short distances.

The determination of the first distance E1 is based on the first response message AN1. Preferably, the first response message AN1 comprises an original transmission signal strength and/or a packet error rate.

Preferably, when determining the first distance E1, a signal strength, also referred to as received signal strength indicator (RSSI), of the received first response message AN1 is determined. As expected, the RSSI is between -30 and -90 dBm. The signal strength is considered excellent if values close to -30 dBm are not reached and the signal strength is considered particularly poor if values close to -90 dBm are reached. The first distance E1 is estimated depending on the signal strength. For example, if the RSSI is close to -30, the distance is assumed to be very small. For example, if the RSSI is close to -90, the distance is assumed to be very great.

Preferably, in addition to determining the signal strength of the first response message AN1 in the field device 1, an original transmission signal strength with which the first response message AN1 was transmitted by the mobile device 2 is stored, and/or the original transmission signal strength is appended to or contained in the first response message AN1. In such case, it is possible to determine the first distance E1 on the basis of the signal strength and the original transmission signal strength. Here it is assumed that there are no obstacles on the transmission path.

The initial transmission signal strength of the first response message AN1 is preferably maximum. This is particularly advantageous because the mobile device 2 has fewer power constraints.

Preferably, a packet error rate of the first response message AN1 is also determined. If the packet error rate is high, the distance is likely to be great. If the packet error rate is small, the distance is likely to be small. The packet error rate is determined, for example, by evaluating a cyclic redundancy check (CRC) of the received packet contents.

The first distance E1 can then be estimated on the basis of the determined packet error rate or determined RSSI of the first response message AN1.

If a synchronous connection has already been established, the distance can also be determined using RSSI and packet error rate.

According to an alternative and/or complementary embodiment, the first distance E1 is determined on the basis of the phase or signal propagation time measurement performed during a connection established after the exchange of the advertising messages (known as channel sounding when using Bluetooth).

When measuring signal propagation times, the field device 1 determines a first time period, also referred to as signal propagation time, between transmitting a message and receiving a response message with known latencies for processing and responding to packets. The propagation speed is assumed to be the propagation speed in air. The first distance is then determined using the propagation speed and the first time period. In phase-based measurement using Bluetooth channel sounding, one of the two communication participants (field device or mobile device) transmits a message with a known phase position. The receiver of the message replies with a message the phase of which is identical to the phase measured in the incoming packet. If the phase of a received response message is measured at different frequencies, the distance between the field device and the mobile device can be calculated therefrom.

### Adaptive adjustment of connection parameters:

After the first distance E1 has been determined using one of the two techniques described above, the required transmission power, data rate of the wireless interface, redundancy of the payload data, the number of payload bytes per packet, and the interval at which packets are exchanged are determined.

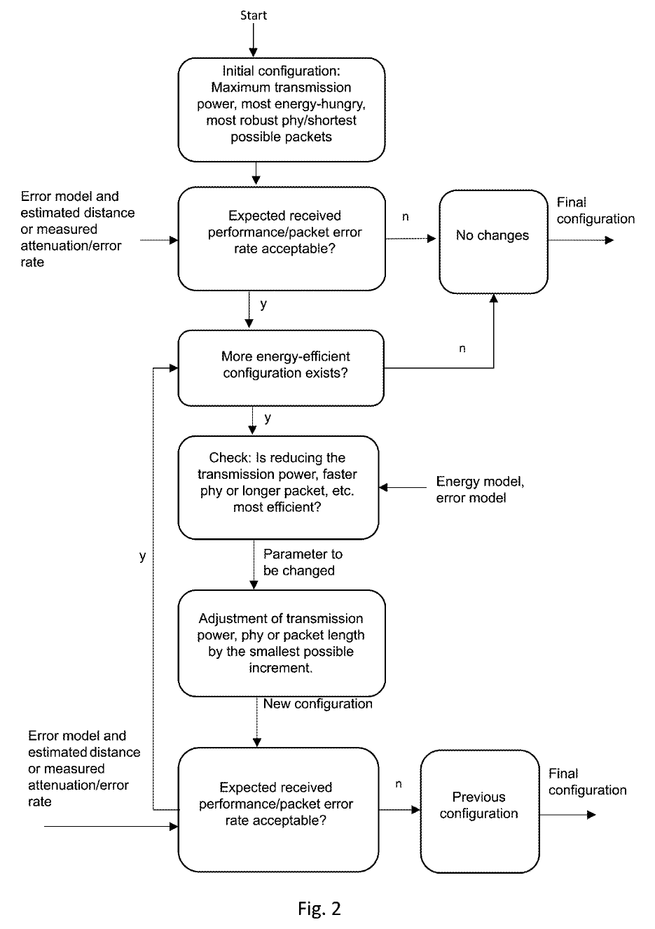

First, the procedure for adjusting these connection parameters is described, as shown in FIG. 2. The effect of each connection parameter to be adjusted is then described in detail.

An algorithm is used to adjust the connection parameters. The algorithm used to find the optimized settings works as follows (cf. FIG. 2). First, the most energy-hungry but most robust configuration of the connection parameters is assumed. This ensures a maximum range when transmitting, i.e., the maximum possible distance between the field device and the mobile device. On the basis of the estimated first distance E1, measured attenuation or measured packet error rate and an error model, it is estimated whether the communication with these connection parameters is sufficiently robust, i.e., whether it has a minimum connection robustness. If this is not the case, the required robustness of the communication, i.e., the minimum connection robustness, cannot be achieved and the algorithm ends with the most robust configuration supported by the wireless interface 30. However, if the required robustness (minimum connection robustness) is achieved, it is checked whether a more energy-efficient configuration of the connection parameters exists that is supported by the wireless interface 30. The next more energy-efficient configurations of both the transmission power, the physical layer (also referred to as phy) and the number and length of packets per connection interval are investigated. Here, a connection interval is understood to mean an exchange of a message transmitted by the field device 1 and received by the field device 1. At the same time, only such configurations are permitted for which an error model shows that the required robustness is still achieved.

If the required robustness (minimum connection robustness) is not achieved by any more energy-efficient configuration, the previous configuration is kept and the algorithm is changed. Otherwise, the next more energy-efficient configuration of the connection parameters supported by the wireless module is selected again and the procedure described above is followed. This is done until the most energy-efficient configuration exhibiting the required robustness has been determined.

Since this method is based on error models, the algorithm can run several iterations and find the most efficient configuration without having to gradually adjust the connection parameters of the wireless interface 30. Since models can only approximate reality, iterative adaptation and measurement of robustness data, i.e., connection robustness (based on packet error rate and received power), is also possible. Both approaches can also be combined.

Since the mobile device 2 can move away from the field device 1 at any time or change its location such that the line of sight between the two devices is at least partially obscured, the described procedure for adapting the connection parameters to propagation time is continuously repeated.

The connection parameters affect the wireless interface 30 and its power consumption as follows.

The transmission power determines the packet error rate and range. Higher transmission power potentially reduces the error rate and increases the range. The physical layer used also influences the range of the wireless connection. When using Bluetooth, there are, for example, different physical layers with different data rates: 1 Mbit/s and 2 Mbit/s. At higher data rates, packets require a shorter transmission time. The transmission of a certain number of bytes via the first wireless interface 30 is also shortened, which in turn reduces energy consumption. At the same time, however, the range of the transmission and its robustness against interference also decreases. Also, corrupted symbols can be corrected after reception using forward error correction (FEC). With Bluetooth, this is done, for example, by using the options coded phy S2 (double redundancy) and coded phy S8 (eightfold redundancy).

For example, coded phy S2 introduces 2 redundancy bits per payload data bit and coded phy S8 introduces 8 redundancy bits per payload data bit. This reduces the data rate and increases energy consumption. However, range and interference immunity are greatly increased. The physical layer can therefore be selected depending on the desired data rate, robustness and energy-optimized transmission power.

Complementary to defining the physical layer (and thus the rate at which bits in a message are transmitted), an initial message length is defined depending on the first distance E1. When defining the initial message length, the number of payload bytes in the messages transmitted is determined. The Bluetooth standard moreover allows the interface to be optionally operated also with particularly long packets using data length extension (DLE).

The advantage of long telegrams, i.e., a first data message DN1 with a great first data length, is that the ratio between protocol overhead and payload data becomes more advantageous for longer telegrams. However, if a bit is transmitted incorrectly when using a physical layer without FEC, the entire message is discarded and must be retransmitted. When using FEC, some errors can be corrected; however, if the bit error rate is too high, errors that cannot be corrected will occur and the entire packet must be retransmitted. Such retransmission significantly increases energy consumption. The bit error rate depends, among other things, on the attenuation in the wireless channel and thus also on the distance between transmitter and receiver. The longer a telegram is, the higher the probability that it contains at least one incorrectly transmitted bit, given the bit error rate.

For short distances and low bit error rates on the radio channel, the use of longer telegrams is therefore advantageous when it comes to energy consumption. For longer distances and thus higher bit error rates, shorter packet lengths are more advantageous. For a given bit error rate, the lowest possible energy consumption is thus always determined by an optimal combination of the physical layer used and the packet length. The optimal combination in a given situation can be calculated from mathematical models on propagation time. This is why the physical layer and the packet length, i.e., the first data length, are preferably continuously optimized with regard to propagation time by the first processing unit 10.

Advantageously, a communication protocol is used which first splits a serial byte stream into individual datagrams of variable size on the transmitter side and then reassembles the datagrams of variable size on the receiver side and initiates repeated transmission if individual datagrams are lost. The use of such a data link layer makes it possible to continue using application protocols at a higher layer regardless of the length of the packets transmitted over the radio, i.e., to operate long transmission distances with short datagrams and short transmission distances with longer datagrams at the application level without the application itself changing the size of the data to be transmitted.

Subsequently, a first data rateis set accordingly depending on the first distance E1. For this purpose, the first processing unit 10 changes the packet rate, i.e., the number of messages per time. When using Bluetooth, this is done by setting a period. If no connection has been established yet, the advertising messages are exchanged at approximately this period. The connection interval is set accordingly in a connection. After each connection interval, either one or more packet pairs can be exchanged between the field device and the mobile device. If a longer packet length is supported than that supported by the Bluetooth standard or the radio hardware, several packet pairs can be exchanged one after the other. The optimal number of packets also follows from the energy model.

By adaptively adjusting the transmission power, data rate and redundancy of the physical layer, the message length, the packet rate and the number of consecutive packet pairs, the lowest possible energy consumption for wireless communication is achieved while still maintaining optimal performance. The energy saved in this way is invested in a higher rate of messages exchanged with the same energy consumption and thus in a lower latency of the wireless connection. On the other hand, part of the saved power is available to the device for other functions that are not related to wireless communication.

The method described above is preferably repeated regularly, since the mobile device 2 may have moved and the first distance E1 thus may no longer be current. As described above in connection with determining the first distance E1, a second distance E2, or second connection robustness, is hence determined. For example, a second advertising message WN2, a second response message AN2 and a second data message DN2 are exchanged. The procedure shown in FIG. 2 can preferably be modified such that the use of error models becomes redundant: Instead of evaluating the adaptation of the connection parameters on the basis of the model, the parameter of the wireless interface can also be adapted, and the received signal power and packet error rate can be monitored at propagation time. If the performance is too low or the error rate is too high, the system will revert to the previous configuration.

The proposed method can increase the data rate of Bluetooth devices and reduce their latency by adapting the transmission power to the required transmission power. This leads to higher performance or, with the same power budget, to increased robustness (connection robustness) of the communication.

1. A method for transmitting data via a wireless interface between a field device and a mobile device, the method comprising:
providing the field device with a processing unit and a first wireless interface, wherein an internal power limit and a minimum connection robustness are stored in the field device;
providing the mobile device with a second wireless interface;
configuring first connection parameters with a first transmission power, a first redundancy and a first packet length, wherein the first transmission power corresponds to a maximum transmission power, the first redundancy to a minimum redundancy, and the first packet length to a minimum packet length so that the internal power limit is not exceeded by the field device;
transmitting a first advertising messagefrom the field device via the first wireless interface with the first connection parameters;
receiving the first advertising message by the mobile device via the second wireless interface;
transmitting a first response messagefrom the mobile device to the field device;
receiving the first response message by the field device;
determining a first signal strength and a first packet error rate on the basis of the first response message by the processing unit;
determining a first connection robustness between the field device and the mobile device on the basis of the first signal strength and the first packet error rate by the processing unit;
comparing the first connection robustness with the minimum connection robustness;
transmitting a first data message with the first connection parameters if the first connection robustness is less than or equal to the minimum connection robustness;
configuring second connection parameters with a second transmission power, a second redundancy and a second packet length, wherein the second transmission power is less than the first transmission power, the second redundancy is greater than the first redundancy, and the second packet length is greater than the first packet length, so that the internal power limit is not exceeded by the field device; and
transmitting the first data message with the second connection parameters if the first connection robustness is greater than the minimum connection robustness.

2. The method according to claim 1, wherein the first wireless interface and the second wireless interface are each a Bluetooth low energy module and are each capable of transmitting at a first data rate or at a second data rate, wherein the second data rate is greater than the first data rate,
wherein the first connection parameters further include the first data rate and the second connection parameters further include the second data rate.

3. The method according to claim 1, wherein the first connection parameters have a first redundancy bit number and the second connection parameters have a second redundancy bit number, wherein the first redundancy bit number is greater than the second redundancy bit number.

4. The method according to claim 1, wherein the first connection parameters have a first telegram length and the second connection parameters have a second telegram length, wherein the first telegram length is smaller than the second telegram length.

5. The method according to claim 1, further comprising:
configuring the second connection parameters using an algorithm, energy model, or error model when the first connection robustness is greater than the minimum connection robustness.

6. The method according to claim 1, further comprising:
after transmitting the first data message repeating all previously performed steps until the first connection robustness is less than or equal to the minimum connection robustness.

7. The method according to claim 1,
wherein the first data message has a first phase position, the method further comprising:
receiving the first data message at the mobile device;
transmitting a second data message with a second phase position;
receiving the second data message at the field device;
evaluating the first phase position and the second phase position, and determining a distance between the field device and the mobile device on the basis of the evaluation.

8. The method according to claim 1, further comprising:
the processing unit storing a transmission time when transmitting the first data message;
receiving the first data message at the mobile device;
transmitting a second data message;
receiving the second data message at the field device;
storing a reception time of the second data message at the field device by the processing unit;
determining a signal propagation time on the basis of the transmission time and reception time; and
determining a distance between the field device and the mobile device on the basis of the signal propagation time.

9. A system, comprising:
a field device with a first wireless interface (30); and
a mobile device with a second wireless interface,
wherein an internal power limit is stored in the field device,
wherein the system is configured to carry out the method according to claim 1.

10. The system according to claim 9, wherein the first wireless interface and the second wireless interface are each a Bluetooth interface.
